(19) United States
(12) Patent Application Publication
(10) Pub. No.: US 2007/0128363 A1
(43) Pub. Date: Jun. 7, 2007

(54) Platinum plated powder metallurgy turbine disk for elevated temperature service

(75) Inventors: Derek A. Rice, Phoenix, AZ (US); Andrew F. Hieber, Scottsdale, AZ (US); Daniel J. Greving, Portland, OR (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC.

(21) Appl. No.: 11/297,231

(22) Filed: Dec. 7, 2005

(51) Int. Cl. B05D 1/32; B05D 1/36

(52) U.S. Cl. 427/282; 428/670; 427/419.1

(57) ABSTRACT

Apparatus and compositions for a turbine disk capable of sustained operation at turbine disk rim temperatures in excess of 1300° F., wherein the turbine disk comprises a superalloy substrate, and a ductile oxidation barrier coating disposed on at least an outer portion of the turbine disk. The oxidation barrier coating may comprise a ductile metal, such as platinum, palladium, or platinum alloyed with Al, Cr, Ni, Pd, Ti, or Zr. Methods for providing an oxidation barrier-coated turbine disk are also disclosed.

### BACKGROUND OF THE INVENTION

The present invention relates generally to turbine disks for gas turbine engines, and more particularly to turbine disks having an oxidation barrier coating.

Gas turbine engines having hotter exhaust gases and which operate at higher temperatures are more efficient. To maximize the efficiency of gas turbine engines, attempts have been made to form gas turbine engine components, such as turbine disks, having higher operating temperature capabilities (e.g., above about 1300° F.). In particular, there is considerable commercial interest in superalloy components for turbine disk applications which exhibit dwell fatigue and creep resistance at relatively high temperatures (e.g., exceeding about 1300° F.).

Conventional alloy turbine disks are limited to an operating temperature of <1300° F. (typically about 1100° F.). Such disks are typically made by inert gas atomization of the alloys into powder form. The powder may be subsequently screened to an appropriate size range and consolidated by hot compaction or by hot isostatic pressing (HIP). The consolidated powder may be then extruded into a form suitable for isothermal forging into a shape that can be machined into a turbine disk or other engine component. Components may also be formed by hot isostatic pressing (HIP) without the extrusion and isothermal forging steps, and subsequently machined to final shape. These methods of manufacture are common throughout the industry and well known in the art. However, providing a conventional turbine disk for sustained elevated temperature service is problematic because resistance to dwell fatigue and corrosion resistance properties for conventional alloy turbine disks tend to be poor at temperatures greater than about 1300° F.

As can be seen, there is a need for apparatus, compositions, and methods for providing components for gas turbine engines, such as turbine disks, capable of sustained operation at turbine disk rim temperatures in excess of 1300° F.

### SUMMARY OF THE INVENTION

In one aspect of the present invention, a coated component comprises a turbine disk, and an oxidation barrier coating disposed on at least an outer portion of the turbine disk; wherein the turbine disk comprises a superalloy, and the oxidation barrier coating comprises a ductile metal.

In a further aspect of the present invention, there is provided a coated component comprising a turbine disk and a platinum coating disposed on an outer portion of the turbine disk; wherein the turbine disk comprises a nickel-based superalloy or a cobalt-based superalloy, and the platinum coating consists essentially of platinum.

In another aspect of the present invention, a coated component comprises a turbine disk, and an oxidation barrier coating disposed on at least an outer portion of the turbine disk, wherein the turbine disk comprises a superalloy, and the oxidation barrier coating comprises palladium, platinum, nickel, or a platinum alloy.

In yet a further aspect of the present invention, a coated component comprises a turbine disk, and an oxidation barrier coating disposed on at least an outer portion of the turbine disk, wherein the turbine disk comprises a superalloy, and the oxidation barrier coating comprises a binary platinum alloy comprising Al, Cr, Ni, Pd, Ti, or Zr.

In yet another aspect of the present invention, a method for preparing a coated component comprises providing a turbine disk, and applying an oxidation barrier coating to at least an outer portion of the turbine disk, wherein the turbine disk comprises a superalloy, and the oxidation barrier coating comprises platinum, palladium, nickel, or a platinum alloy.

These and other features, aspects, and advantages of the present invention will become better understood with reference to the following drawings, description, and claims.

### BRIEF DESCRIPTION OF THE DRAWINGS

FIG. 1A is a perspective view of a high temperature turbine disk for a gas turbine engine, according to an aspect of the instant invention;

FIG. 1B is a sectional view of an oxidation barrier coating disposed on a turbine disk surface, also according to the instant invention;

FIG. 2 schematically represents a series of steps involved in a method for preparing an alloy turbine disk having an oxidation barrier coating, according to another embodiment of the invention;

FIG. 3A is a plan view of a masked turbine disk, according to another aspect of the instant invention;

FIG. 3B is a radial sectional view of the masked disk of FIG. 3A;

FIG. 4A is a scanning electron micrograph of a section of an oxidation barrier coating on a superalloy substrate, according to another aspect of the instant invention; and

FIG. 4B is an energy dispersive X-ray spectrum of the oxidation barrier coating of FIG. 4A.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides apparatus, compositions, and methods for providing coated components for gas turbine engine operation at sustained high temperatures (e.g., >1300° F.). In one embodiment, the present invention provides an alloy turbine disk or rotor having a ductile oxidation barrier coating (OBC) disposed on at least an outer portion thereof. The present invention may find applications in turbomachinery, including turbo fan, turbo shaft, and turbo prop engines. The present invention may be used for gas turbine engine of aircraft, as well as for industrial turbomachinery for power generation, and the like.

Alloy turbine disks of the present invention may include an oxidation barrier coating disposed on at least an outer portion of the turbine disk, wherein the oxidation barrier coating may comprise a layer of ductile metal, e.g., comprising platinum (Pt), palladium (Pd), or a Pt alloy. The ductile oxidation barrier coating on the outer portion or rim of the turbine disk of the present invention may prevent surface oxide formation and intergranular attack, thereby delaying the onset of surface initiated low cycle fatigue (LCF) cracking, hence, the component life of the coated turbine disks of the present invention may be dramatically extended. In contrast to the present invention, turbine disks of the prior art lack a ductile oxidation barrier coating on the outer rim of the disk. Consequently, turbine disks of the prior art are readily susceptible to oxidation and corrosion, resulting in greatly decreased life of conventional components.

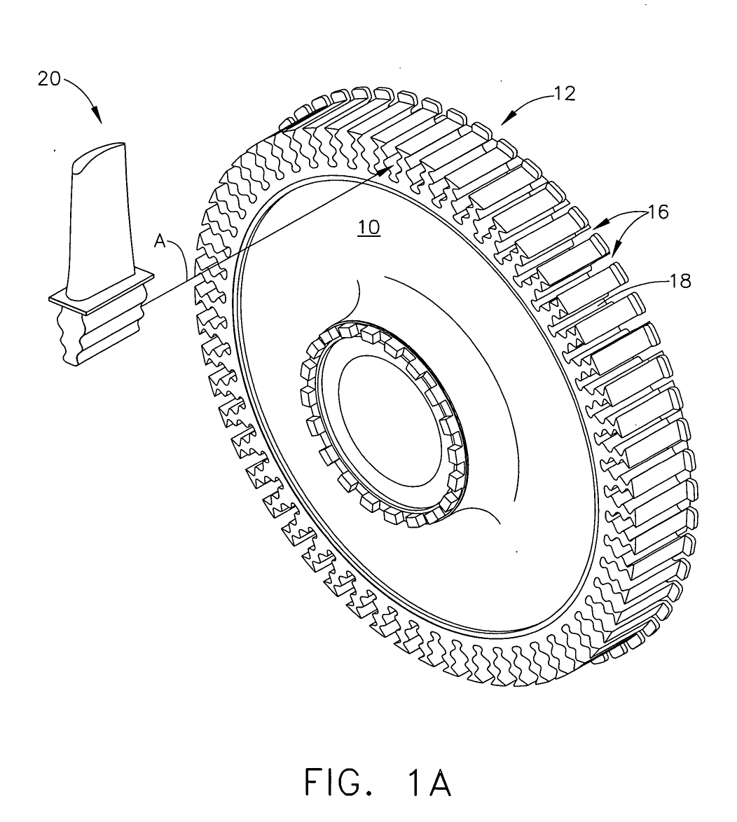

FIG. 1A is a perspective view of a turbine disk 10 including an oxidation barrier coating (OBC) 14 (see, for example, FIG. 1B), according to an embodiment of the instant invention. Turbine disk 10 may also be referred to by one of ordinary skill in the art as a rotor. Turbine disk 10 may include a disk outer portion 12. Outer portion 12 may also be referred to as an outer rim of turbine disk 10. Turbine disk 10 may further include a plurality of blade attachment slots 16, which may be disposed circumferentially on outer portion 12. Each blade attachment slot 16 may be configured for attachment of a turbine blade 20, as indicated by arrow A. Such attachment of turbine blades 20 to turbine disk 10 via blade attachment slots 16 is well known in the art. Turbine disk 10 may further include a blade attachment surface 18 located within each blade attachment slot 16. Turbine blade 20 may be a conventional turbine blade well known in the art. Turbine disk 10 may comprise a superalloy, which may be, for example, a nickel-based superalloy or a cobalt-based superalloy.

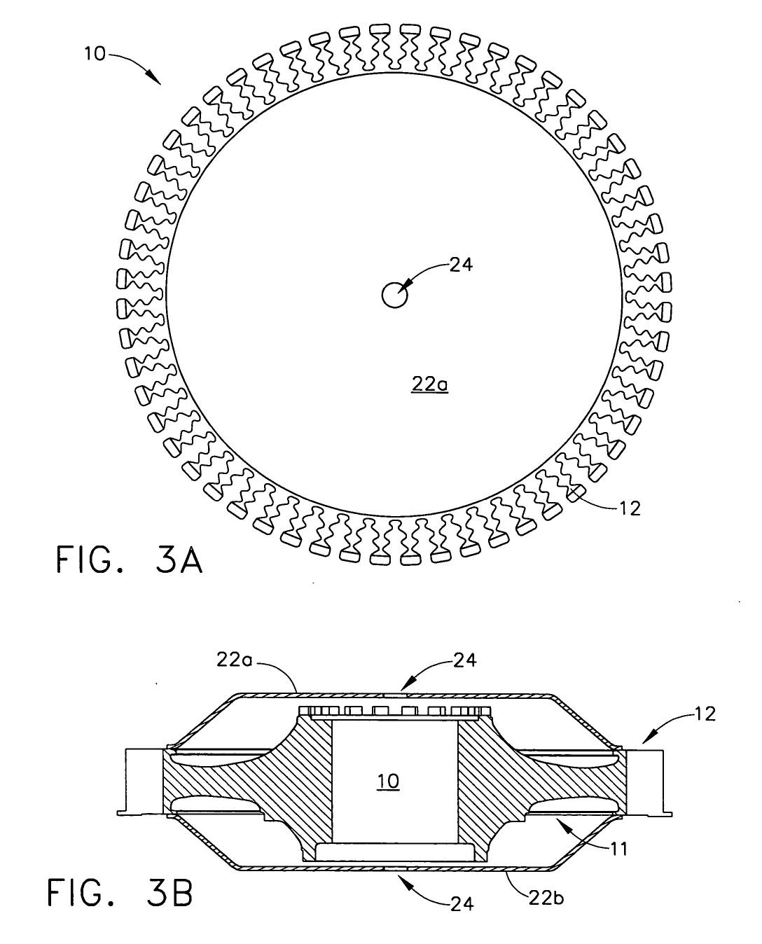

FIG. 1B is a sectional view of a portion of turbine disk 10 showing oxidation barrier coating 14 disposed on disk surface 10a of turbine disk 10, also according to the instant invention. Oxidation barrier coating 14 may be selectively applied to disk outer portion 12 (see, for example, FIGS. 3A-B) such that an inner portion 11 (see, FIG. 3B) of turbine disk 10 may lack oxidation barrier coating 14. Selective deposition of oxidation barrier coating 14 to disk outer portion 12 may decrease both the cost and weight of turbine disk 10. Disk surface 10a may comprise blade attachment surface 18 (see, FIG. 1A). Naturally, disk outer portion 12 may not be limited to blade attachment surface 18. Oxidation barrier coating 14 may serve to prevent oxidation and corrosion of disk outer portion 12, including blade attachment slots 16. By preventing oxidation and corrosion of turbine disk 10, thereby delaying the onset of LCF cracking, the life of turbine disk 10 may be extended by more than two orders of magnitude as compared with conventional, uncoated alloy turbine disks of the prior art.

Oxidation barrier coating 14 may be a ductile coating. Oxidation barrier coating 14 may be resistant to prolonged exposure to temperature cycling at temperatures up to >1300° F. without cracking or spalling. Oxidation barrier coating 14 may comprise a ductile metal such as, but not limited to, platinum (Pt). In exemplary embodiments of the present invention, oxidation barrier coating 14 may comprise typically at least about 97 wt. % platinum, usually at least about 99 wt. % platinum, and often at least about 99.9 wt. % platinum. In some exemplary embodiments of the present invention, oxidation barrier coating 14 applied to disk outer portion 12 may consist essentially of platinum.

In some embodiments of the present invention, oxidation barrier coating 14 may comprise a platinum alloy. Oxidation barrier coating 14 may comprise a binary platinum alloy. Oxidation barrier coating 14 may comprise Pt alloyed with aluminum (Al), chromium (Cr), titanium (Ti), nickel (Ni), palladium (Pd), or zirconium (Zr). In some embodiments of the present invention, oxidation barrier coating 14 may comprise nickel (Ni), palladium (Pd), or an alloy of Ni or Pd with Pt. In various embodiments of the present invention, oxidation barrier coating 14 may comprise: a Pt/Al alloy comprising about 3.75-23.1 wt. % Al, 76.9-96.25 wt. % Pt; a Pt/Cr alloy comprising about 0-60 wt. % Cr, 40-100 wt. % Pt; a Pt/Ni alloy comprising about 0-100 wt. % Ni, 0-100 wt. % Pt; a Pt/Pd alloy comprising about 0-100 wt. % Pd, 0-100 wt. % Pt; a Pt/Ti alloy comprising about 0-46 wt. % Ti, 54-100 wt. % Pt; or a Pt/Zr alloy comprising about 0-28 wt. % Zr, 72-100 wt. % Pt. Typically, the Pt/Ni alloy in the form of an intermetallic may comprise about 0-47 wt. % Ni, 53-100 wt. % Pt. Typically, the Pt/Ni alloy in the form of a solid solution may comprise about 1-50 wt. % Ni, 50-99 wt. % Pt, and usually about 5-50 wt. % Ni, 50-95 wt. % Pt. Typically, the Pt/Pd alloy in the form of a solid solution may comprise about 1-99 wt. % Pt, 1-99 wt. % Pd, and usually about 5-95 wt. % Pt, 5-95 wt. % Pd.

TABLE 1
Wt. % Platinum (Pt) in OBC for Various Stable Phases

| Phase | wt. % Pt |
|---|---|
| Al₂Pt | 76.9-78.5 |
| Al₃Pt₂ | 82.8 |
| AlPt | 87.9 |
| AlPt₃ | >93 |
| Cr₃Pt | 44-53 |
| CrPt | 78-80 |
| CrPt₃ | 66-96 |
| Ni₃Pt | ˜53 |
| NiPt | ˜76.9 |
| Ti₃Pt | 54-63 |
| Ti₃Pt₈ | ˜87.2 |
| TiPts | 97-99.5 |
| Pt₃Zr | ˜86 |
| Pt₁₁Zr₉ | ˜72 |

In some embodiments of the present invention, oxidation barrier coating 14 may comprise an intermetallic or a solid solution. As a non-limiting example, oxidation barrier coating 14 may comprise a solid solution of Ni/Pt or Pd/Pt; or oxidation barrier coating 14 may comprise an intermetallic phase such as Al₂Pt, Al₃Pt₂, AlPt, AlPt₃, Cr₃Pt, CrPt, CrPt₃, Ni₃Pt, NiPt, Ti₃Pt, Ti₃Pt₅, TiPt₈, Pt₃Zr, or Pt₁₁Zr₉. Oxidation barrier coating 14 may comprise more than one of these phases within a binary platinum alloy, e.g., oxidation barrier coating 14 may comprise CrPt in combination with CrPt₃. Exemplary values for wt. % platinum of oxidation barrier coating 14 predominantly comprising each of the above phases are shown in Table 1. Each composition presented in Table 1 is a stable phase, as shown by published phase diagrams (see, e.g., Binary Alloy Phase Diagrams for Al (Al—Pt), Cr (Cr—Pt), Ni (Ni—Pt), Pd (Pd—Pt), and Pt (Pt—Ti and Pt—Zr), published by ASM International, 2002).

Oxidation barrier coating 14 may be applied to disk surface 10a using various deposition techniques well known in the art. As non-limiting examples, oxidation barrier coating 14 may be applied to disk surface 10a by physical vapor deposition (PVD), sputter coating, or electroplating.

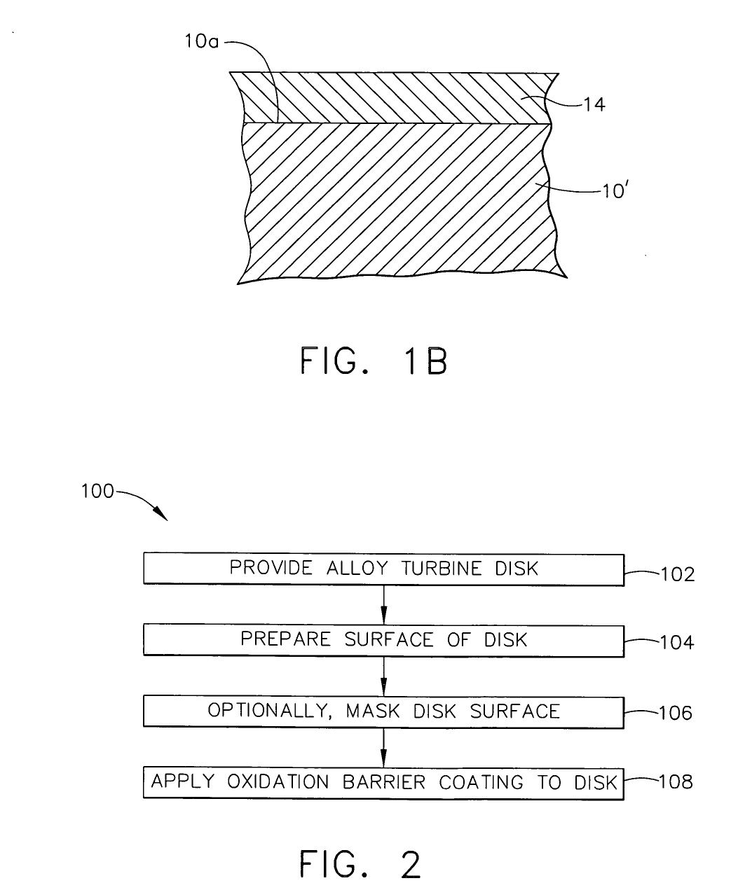

FIG. 2 schematically represents a series of steps involved in a method 100 for preparing a coated component, wherein the component may comprise an alloy, and the component may have an oxidation barrier coating disposed thereon, according to another embodiment of the invention. The component may comprise a turbine disk for a gas turbine engine.

Step 102 of method 100 may involve providing an alloy turbine disk. The turbine disk may be provided according to manufacturing techniques well known in the art, for example, powder metallurgy processes involving hot isostatic pressing (HIP), extrusion, and isothermal forging. Typically, turbine disk 10 may comprise a superalloy, such as a nickel-based superalloy or a cobalt-based superalloy. Such alloys are well known in the art.

Step 104 may involve preparing a surface of the turbine disk. The disk surface may be treated during step 104 such that all surface areas are water-break-free. Shop soils may be removed using a suitable aqueous degreaser or by vapor degreasing. In addition, surface oxides may be removed from the disk surface using a suitable acid etch. Such surface preparation techniques are well known in the art. Once the disk surface has been prepared, the turbine disk may be handled using lint-free cotton gloves.

Step 108 may involve applying the oxidation barrier coating to at least the outer portion of the turbine disk. During step 108, the entire outer portion of the turbine disk, including the blade attachment surface of each blade attachment slot, may be coated with the oxidation barrier coating. The oxidation barrier coating may be applied to the surface of the turbine disk using various deposition techniques, such as physical vapor deposition (PVD), sputter coating, or electroplating. Such deposition techniques are well known in the art. The oxidation barrier coating may be applied to the surface of the turbine disk as a single layer or as a plurality of layers.

As a result of masking the turbine disk in step 106 (infra), an inner portion of the turbine disk may remain uncoated after step 108 has been performed. That is to say, the oxidation barrier coating may be selectively applied to the outer portion of the turbine disk such that an inner portion of the turbine disk may lack the oxidation barrier coating.

The oxidation barrier coating applied in step 108 may have a thickness typically in the range of from about 800 nm to about 50 microns (0.002 inches), usually from about 800 nm to about 10 microns (μm), and often from about 1 micron to about 3 microns (μm). The oxidation barrier coating applied in step 108 may be a ductile coating which resists cracking and spalling following prolonged exposure to high temperatures (e.g., in excess of 1300° F.) and repeated temperature cycling.

In exemplary embodiments of the present invention, the oxidation barrier coating applied in step 108 may comprise platinum, typically comprising at least about 97 wt. % platinum, usually at least about 99 wt. % platinum, and often at least about 99.9 wt. % platinum. In some embodiments of the present invention, the oxidation barrier coating applied in step 108 may consist essentially of platinum. Optional, step 106 may involve masking the turbine disk such that only an outer portion of the disk is exposed during deposition of the oxidation barrier coating (see, e.g., step 108, infra). As a non-limiting example, the turbine disk may be masked using a pair of metal plates disposed over an inner portion of each side of the turbine disk (see, for example, FIGS. 3A-B). Following masking in step 106, the entire outer portion or outer rim of the turbine disk, including the blade attachment surface of each blade attachment slot (see, FIG. 1A) may be exposed for deposition of the oxidation barrier coating thereon. To preclude entrapment of acid, e.g., between the disk surface and masking materials, step 106 may be performed after step 104.

FIG. 3A is a plan view of a masked turbine disk 10, and FIG. 3B is a radial sectional view of the masked turbine disk 10 of FIG. 3A, according to an aspect of the instant invention. A disk inner portion 11 of turbine disk 10 may be masked preparatory to deposition of the oxidation barrier coating, for example, as described hereinabove with reference to method 100 (FIG. 2).

With reference to FIGS. 3A and FIG. 3B, turbine disk 10 may be masked by a first plate 22a and a second plate 22b disposed over disk inner portion 11. First plate 22a and second plate 22b may each comprise, as an example, a formed metal plate, e.g., comprising Ni/steel, or the like, and having a bore 24 therethrough. First plate 22a and second plate 22b may be clamped in place, e.g., via a bolt (not shown) extending through bore 24 of first plate 22a and second plate 22b. When first plate 22a and second plate 22b are clamped against turbine disk 10, the entire disk outer portion 12 may be exposed for deposition thereon of oxidation barrier coating 14 (see, FIG. 1B).

### EXAMPLE 1

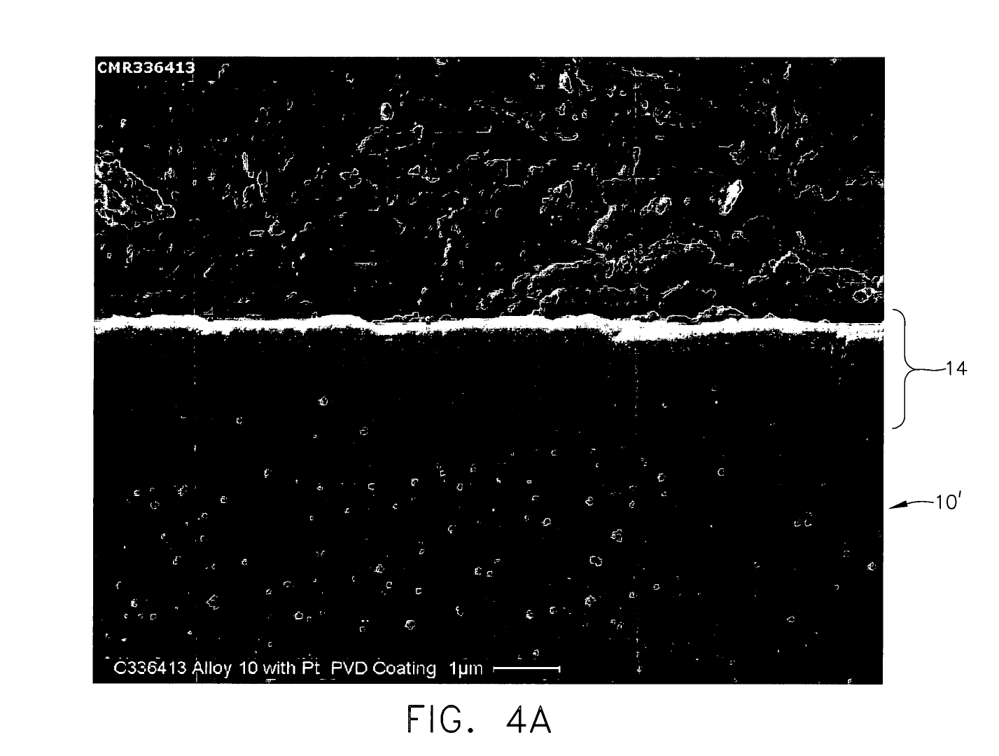

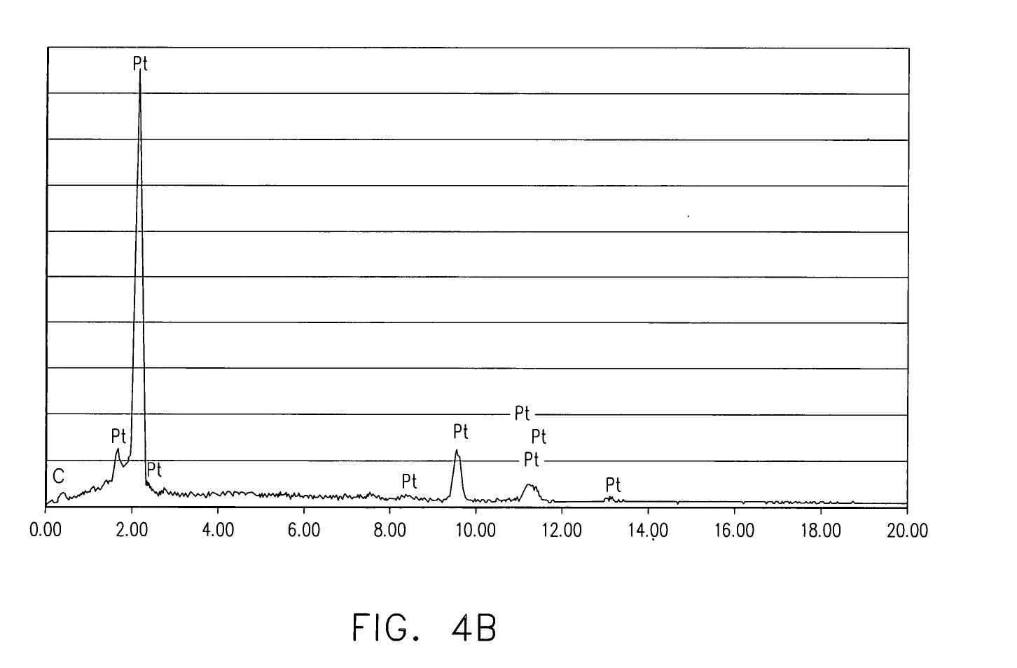

FIG. 4A is a scanning electron micrograph of a section through an oxidation barrier coating 14 disposed as a substantially uniform layer on the surface of a substrate 10′, wherein substrate 10′ comprises Alloy 10 (nickel-based superalloy), according to another aspect of the instant invention. The surface of substrate 10′ was degreased and acid etched to remove surface oxides prior to deposition of oxidation barrier coating 14 by physical vapor deposition (PVD). The bar shown in FIG. 4A represents 1 μm. FIG. 4B shows the results of energy dispersive X-ray (EDX) spectrometry of the oxidation barrier coating 14 of FIG. 4A. The EDX spectrum shown in FIG. 4B indicates that the oxidation barrier coating 14 of FIG. 4A consists of substantially pure platinum (Pt).

It is to be understood that the invention is not limited to coatings comprising platinum or platinum alloys, but rather other ductile oxidation barrier coatings which may effectively protect alloy turbine disks from corrosion and oxidation are also within the scope of the present invention.

Although the invention has been described primarily with respect to turbine disks, the present invention may also find applications for other components of gas turbine engines, and the like.

It should be understood, of course, that the foregoing relates to exemplary embodiments of the invention and that modifications may be made without departing from the spirit and scope of the invention as set forth in the following claims.

We claim:

1. A coated component, comprising:
a turbine disk; and
an oxidation barrier coating disposed on at least an outer portion of said turbine disk; wherein:
said turbine disk comprises a superalloy, and
said oxidation barrier coating comprises a ductile metal.

2. The coated component according to claim 1, wherein said oxidation barrier coating comprises platinum.

3. The coated component according to claim 1, wherein said oxidation barrier coating comprises at least about 97 wt. % platinum.

4. The coated component according to claim 1, wherein said oxidation barrier coating comprises at least about 99 wt. % platinum.

5. The coated component according to claim 1, wherein said oxidation barrier coating comprises at least about 99.9 wt. % Pt.

6. The coated component according to claim 1, wherein said oxidation barrier coating consists essentially of platinum.

7. The coated component according to claim 1, wherein said turbine disk comprises a nickel-based superalloy or a cobalt-based superalloy.

8. The coated component according to claim 1, wherein said oxidation barrier coating has a thickness of from about 800 nm to about 50 microns (μm).

9. The coated component according to claim 1, wherein:
said oxidation barrier coating is disposed on said outer portion of said turbine disk, and
an inner portion of said turbine disk is uncoated by said oxidation barrier coating.

10. The coated component according to claim 1, wherein:
said outer portion comprises a plurality of blade attachment slots,
each said blade attachment slot comprises a blade attachment surface, and
said oxidation barrier coating is disposed on said blade attachment surface.

11. The coated component according to claim 1, wherein said oxidation barrier coating comprises a platinum alloy comprising platinum alloyed with a material selected from the group consisting of Al, Cr, Ni, Ti, Pd, and Zr.

12. The coated component according to claim 11, wherein said platinum alloy comprises a binary platinum alloy.

13. The coated component according to claim 1, wherein said oxidation barrier coating comprises an intermetallic selected from the group consisting of Al₂Pt, Al₃Pt₂, AlPt, AlPt₃, Cr₃Pt, CrPt, CrPt₃, Ni₃Pt, NiPt, Ti₃Pt, Ti₃Pt₅, TiPt₈, Pt₃Zr, Pt₁₁Zr₉.

14. The coated component according to claim 1, wherein said oxidation barrier coating comprises platinum and a solid solution of Pd or Ni in said platinum.

15. A coated component, comprising:
a turbine disk; and
a platinum coating disposed on an outer portion of said turbine disk; wherein:
said turbine disk comprises a nickel-based superalloy or a cobalt-based superalloy, and
said platinum coating consists essentially of platinum.

16. The coated component according to claim 15, wherein:
said outer portion of said turbine disk comprises a plurality of blade attachment slots, and
said platinum coating is coated on each of said plurality of blade attachment slots.

17. The coated component according to claim 16, wherein said platinum coating has a thickness of from about 800 nm to about 10 microns (μm).

18. A coated component, comprising:
a turbine disk; and
an oxidation barrier coating disposed on at least an outer portion of said turbine disk; wherein:
said turbine disk comprises a superalloy, and
said oxidation barrier coating comprises palladium, platinum, nickel, or a platinum alloy.

19. The coated component according to claim 18, wherein said oxidation barrier coating comprises a binary platinum alloy.

20. The coated component according to claim 18, wherein said oxidation barrier coating comprises a platinum alloy comprising platinum and a material selected from the group consisting of Al, Cr, Ni, Pd, Ti, and Zr.

21. The coated component according to claim 18, wherein said oxidation barrier coating comprises a Pt/Al alloy comprising about 3.75-23.1 wt. % Al and 76.9-96.25 wt. % Pt.

22. The coated component according to claim 18, wherein said oxidation barrier coating comprises a Pt/Cr alloy comprising about 0-60 wt. % Cr and 40-100 wt. % Pt.

23. The coated component according to claim 18, wherein said oxidation barrier coating comprises a Pt/Ni alloy comprising about 0-47 wt. % Ni and 53-100 wt. % Pt.

24. The coated component according to claim 18, wherein said oxidation barrier coating comprises a Pt/Pd alloy comprising 1-99 wt. % Pt and 1-99 wt. % Pd.

25. The coated component according to claim 18, wherein said oxidation barrier coating comprises a Pt/Ti alloy comprising 0-46 wt. % Ti and 54-100 wt. % Pt.

26. The coated component according to claim 18, wherein said oxidation barrier coating comprises a Pt/Zr alloy comprising 0-28 wt. % Zr and 72-100 wt. % Pt.

27. A coated component, comprising:
a turbine disk; and
an oxidation barrier coating disposed on at least an outer portion of said turbine disk; wherein:
said turbine disk comprises a superalloy, and
said oxidation barrier coating comprises a binary platinum alloy comprising Al, Cr, Ni, Pd, Ti, or Zr.

28. The coated component according to claim 27, wherein said binary platinum alloy comprises a solid solution of Pd or Ni.

29. The coated component according to claim 27, wherein said binary platinum alloy comprises an intermetallic selected from the group consisting of Al₂Pt, Al₃Pt₂, AlPt, AlPt₃, Cr₃Pt, CrPt, CrPt₃, Ni₃Pt, NiPt, Ti₃Pt, Ti₃Pt₅, TiPt₈, Pt₃Zr, and Pt₁₁Zr₉.

30. A method for preparing a coated component comprising:
a) providing a turbine disk; and
b) applying an oxidation barrier coating to at least an outer portion of said turbine disk, wherein:
said turbine disk comprises a superalloy, and
said oxidation barrier coating comprises platinum, palladium, nickel, or a platinum alloy.

31. The method for preparing a coated component according to claim 30, further comprising:
c) prior to said step b), masking an inner portion of said turbine disk.

32. The method for preparing a coated component according to claim 31, further comprising:
d) prior to said step c), removing surface oxides from said turbine disk.

33. The method for preparing a coated component according to claim 30, wherein said step b) comprises selectively applying said oxidation barrier coating to said outer portion of said turbine disk.

34. The method for preparing a coated component according to claim 30, wherein said step b) comprises applying said oxidation barrier coating to said turbine disk by a deposition process selected from the group consisting of physical vapor deposition (PVD), sputter coating, and electroplating.

35. The method for preparing a coated component according to claim 30, wherein said oxidation barrier coating comprises at least about 97 wt. % wt. % platinum.

36. The method for preparing a coated component according to claim 30, wherein said oxidation barrier coating comprises at least about 99 wt. % platinum.

37. The method for preparing a coated component according to claim 30, wherein said oxidation barrier coating comprises at least about 99.9 wt. % platinum.

38. The method for preparing a coated component according to claim 30, wherein said oxidation barrier coating consists essentially of platinum.

39. The method for preparing a coated component according to claim 30, wherein said binary platinum alloy comprises Al, Cr, Ni, Pd, Ti, or Zr.

40. The method for preparing a coated component according to claim 39, wherein said binary platinum alloy comprises a solid solution of Pd or Ni.

41. The method for preparing a coated component according to claim 30, wherein said oxidation barrier coating comprises an intermetallic selected from the group consisting of Al₂Pt, Al₃Pt₂, AlPt, AlPt₃, Cr₃Pt, CrPt, CrPt₃, Ni₃Pt, NiPt, Ti₃Pt, Ti₃Pt₅, TiPt₈, Pt₃Zr, and Pt₁₁Zr₉.

42. The method for preparing a coated component according to claim 30, wherein said oxidation barrier coating comprises a material selected from the group consisting of a Pt/Al alloy comprising 3.75-23.1 wt. % Al, 76.9-96.25 wt. % Pt; a Pt/Cr alloy comprising 0-60 wt. % Cr, 40-100 wt. % Pt; a Pt/Ni alloy comprising 0-47 wt. % Ni, 53-100 wt. % Pt; a Pt/Pd alloy comprising 1-99 wt. % Pt, 1-99 wt. % Pd; a Pt/Ti alloy comprising 0-46 wt. % Ti, 54-100 wt. % Pt; and a Pt/Zr alloy comprising 0-28 wt. % Zr, 72-100 wt. % Pt.

43. The method for preparing a coated component according to claim 30, wherein said oxidation barrier coating has a thickness of from about 800 nm to about 10 microns (μm).

44. The method for preparing a coated component according to claim 30, wherein said oxidation barrier coating protects at least an outer portion of said turbine disk from oxidation and corrosion during exposure of said outer portion of said turbine disk to sustained temperatures greater than about 1300° F.

45. The method for preparing a coated component according to claim 30, wherein said turbine disk comprises a nickel-based superalloy.
